(19) United States
(12) Patent Application Publication
(10) Pub. No.: US 2017/0200243 A1
(43) Pub. Date: Jul. 13, 2017

(54) SOCIAL NETWORK APPLICATION FOR REAL ESTATE

(71) Applicant: Robert Mahon Morgan, Greenville, SC (US)

(72) Inventor: Robert Mahon Morgan, Greenville, SC (US)

(21) Appl. No.: 15/056,181

(22) Filed: Feb. 29, 2016

Related U.S. Application Data
(60) Provisional application No. 62/128,845, filed on Mar. 5, 2015.

(51) Int. Cl. G06Q 50/16; G06Q 10/10; G06Q 50/00

(52) U.S. Cl. CPC G06Q 50/16; G06Q 50/01; G06Q 10/1093

(57) ABSTRACT

A mobile app for streamlining real estate transactions operable for customers, agents, and real estate managers.

### FIELD OF THE INVENTION

The present invention relates to a system and method and a software application for providing information and coordinating MLS data bases for residential real estate. The application connects clients (potential purchasers) to agents and agents to management.

### BACKGROUND OF THE INVENTION

The housing market in the United States is an essential building block for the entire economy.

Large numbers of residential real estate transactions have the potential for overwhelming the entire system. This is further complicated by the fact that a large percentage of buyers are first time buyers who are unfamiliar with the details required to review in a search for and buying a house.

A number of tools have been provided to assist the buyers and sellers and their agents in attempting to target a collection of suitable houses to relevant, potential purchasers. One of the most well-known is the MLS listing with MLS standing for “Multiple Listing Service.” The MLS listing is generally a regionally based complex database of listings entered directly by real estate professionals. The database is intended to act as a trading platform to buy and sell real estate properties. When a property is on the market for sale it is added to the database and tracked through the sales transaction cycle. MLS listings is a source of information that provides data that fields real estate service sites like Zillow™, Trulia™, and AGENT.COM.

It is clear that there is a need for objectively sharing information amongst the various parties involved in a real estate transaction to provide an efficiently operated system.

### SUMMARY OF THE INVENTION

The present invention provides a social network application (app) with the following features:

1. Compare Homes—Allows for comparing multiple homes at once on one screen with the ability to toggle between multiple comparable options including basic specs, descriptions, pictures (both posted and users), videos (both posted and users), and user notes.

2. Check-in/out/Tracking/Safety—GPS enabled home check in/out to meet the needs of the buyer, seller, real estate agent (agent), and broker-in-charge (BIC)/office as well as safety features.

e. Buyer

i. Check in—When the buyer checks-in at the home, this can be done at any time, they are capable of adding additional notes/pictures/videos to their home to further develop necessary information to drive a purchasing decision.

ii. Check out—When the buyer checks-out at the home they are prompted to provide feedback. 1) It reminds the buyer to update their rating and comments while the showing is fresh on their mind. 2) It helps provide beneficial feedback to the real estate agent AND/OR seller. 3) Prompt the buyer if they need directions to the next scheduled appointment/home.

f. Seller

i. Check in—Feature that allows the seller to know when the scheduled showing appointment has begun as it notifies the seller through text/email (their choice) when the buyer/agent check-in.

ii. Check out—Feature that allows the seller to know when the buyer and agent have finished their showing appointment. The seller will receive instant notification through text/email (their choice) when the showing has completed at their listed home after the buyer/agent check-out. This can be GPS enabled through GEO Boundary Technology.

g. Agent—Feature in place to increase schedule visibility with the intention of improved Agent safety and tracking aby authorized parties.

i. Check-in—Prompts dashboard on Agent's smart phone that gives them the option to access the home screen, notes/feedback, contact office, call 911, or go to home screen. Check-in also alerts BIC or designated office lead that the Agent has started his/her showing appointment.

ii. Check-out—When the Agent leaves the home the Agent is prompted to check-out. The purpose of checking-out is to 1) Remind the Agent to obtain feedback from the buyer that they can then submit to seller 2) Alert the seller the showing is complete and the home is vacant 3) Alert the BIC/office that the Agent has completed the scheduled showing 4) Prompt the Agent if they need directions to their next scheduled showing/home. This can be automated by GEO Boundary.

h. BIC/Office

i. Check-in—Alerts office that the Agent has begun his/her showing and starts a timer. The timer allows the office to track how long the Agent has been at the home with the buyer. The office can adjust the settings on when to contact the Agent if the appointment has extended past the standard period (for instance, if the Agent has not checked out after one hour the office will be notified via test/email/alert to contact the Agent to ensure everything is ok).

ii. Check-out—Notifies the office that the agent has ended his/her scheduled showing.

3. Home Linked Communication—One source of communication between the app users and/or Agents separated into different files for each home in conversation. File can contain all previous conversations/pictures/videos/notes/calendar history will also connect with the user's calendar to link scheduled showings/open house to user's calendar. This revolves around photo of home and MLS number (if available.)

4. Feedback—While viewing homes the customer or agent will have a feedback screen appear or be an option on the showing screen. It will automatically ask for feedback (if GPS enabled) when checking out of a home after a showing. The agent will receive all feedback from the customer viewing the home after the buyer/user has completed feedback and checkout (this will be the listing agent if the buyer has not selected an agent). In the case of the buyer having an agent, the feedback will first be received and is editable by the agent and then can be forwarded to the listing agent or designated contact. If there are multiple showings in one day, all feedback can be sent with one button, or each can be viewed/edited and sent one at a time.

5. Communicating Appointments (Showings)—After an appointment(s) is requested which may be done through a link to a designated app source, the agent can confirm appointment(s) which will go to the “Scheduled Appointments” section of the application. Appointments will show up in the order of the scheduled appointment(s) with a time stamp of the slotted time confirmed. This screen also tracks past showings in order of the date and shows that the showing has been completed when both check-out (triggered by the check-out feature above) and feedback has been sent. The appointment will not be completed or time-stamped until both of the above are completed.

6. 3 Star Rating System—Measure of rating on a scale of 3 stars (1 being the lowest, 3 being the highest). This rating system can be updated through the home buying process and dictates the order or ranking of viewed homes as seen on the “Favorites” screen. This rating is visible to the buyer's agent (if he/she has selected an agent) and helps the agent understand the buyers favorites. The buyer can also move homes up or down by sliding the listing info up or down to give them a preference order with homes of the same 3 star rating. When they select a home to “in the top 3” it will automatically replace the previously ranked 3^{rd} home on the favorite page. The rating is visible to the buyer's agent (if selected) and helps the agent understand the buyer's favorites.

### BRIEF DESCRIPTION OF THE DRAWINGS

FIG. 1 schematically illustrates the operation of a social network.

FIG. 2 is similar to FIG. 1 including the addition of servers.

FIG. 3 illustrates the inclusion of logic into a social network.

FIG. 4 depicts a display screen as it appears on a mobile app.

FIG. 5 depicts a display screen as it appears on a mobile app.

FIG. 6 depicts a display screen as it appears on a mobile app.

FIG. 7 depicts a display screen as it appears on a mobile app.

FIG. 8 depicts a display screen as it appears on a mobile app.

FIG. 9 depicts a display screen as it appears on a mobile app.

FIG. 10 depicts a display screen as it appears on a mobile app.

FIG. 11 depicts a display screen as it appears on a mobile app.

FIG. 12 depicts a display screen as it appears on a mobile app.

FIG. 13 depicts a display screen as it appears on a mobile app.

FIG. 14 depicts a display screen as it appears on a mobile app.

FIG. 15 depicts a display screen as it appears on a mobile app.

FIG. 16 depicts a display screen as it appears on a mobile app.

FIG. 17 depicts a display screen as it appears on a mobile app.

FIG. 18 depicts a display screen as it appears on a mobile app.

FIG. 19 depicts a display screen as it appears on a mobile app.

FIG. 20 depicts a display screen as it appears on a mobile app.

FIG. 21 depicts a display screen as it appears on a mobile app.

FIG. 22 depicts a display screen as it appears on a mobile app.

FIG. 23 depicts a display screen as it appears on a mobile app.

FIG. 24 depicts a display screen as it appears on a mobile app.

FIG. 25 depicts a display screen as it appears on a mobile app.

FIG. 26 depicts a display screen as it appears on a mobile app.

FIG. 27 depicts a display screen as it appears on a mobile app.

FIG. 28 depicts a display screen as it appears on a mobile app.

FIG. 29 depicts a display screen as it appears on a mobile app.

FIG. 30 depicts a display screen as it appears on a mobile app.

FIG. 31 depicts a display screen as it appears on a mobile app.

FIG. 32 depicts a display screen as it appears on a mobile app.

FIG. 33 depicts a display screen as it appears on a mobile app.

FIG. 34 depicts a display screen as it appears on a mobile app.

FIG. 35 depicts a display screen as it appears on a mobile app.

FIG. 36 depicts a display screen as it appears on a mobile app.

FIG. 37 depicts a display screen as it appears on a mobile app.

FIG. 38 depicts a display screen as it appears on a mobile app.

FIG. 39 depicts a display screen as it appears on a mobile app.

FIG. 40 depicts a display screen as it appears on a mobile app.

FIG. 41 depicts a display screen as it appears on a mobile app.

### DETAILED DESCRIPTION

The application of this invention is adaptable for three separate sets of users, all within a single application. The application provides for customer interface on one hand, a real estate agent on the other hand, and yet a third level for real estate managers. The applications will be discussed in the following description with regard to the above entities in the same order. In all three categories, the application searches MLS database for residential real estate which is a starting point for the three categories of users. The technology for carrying the process of this application is described below.

### The Technology

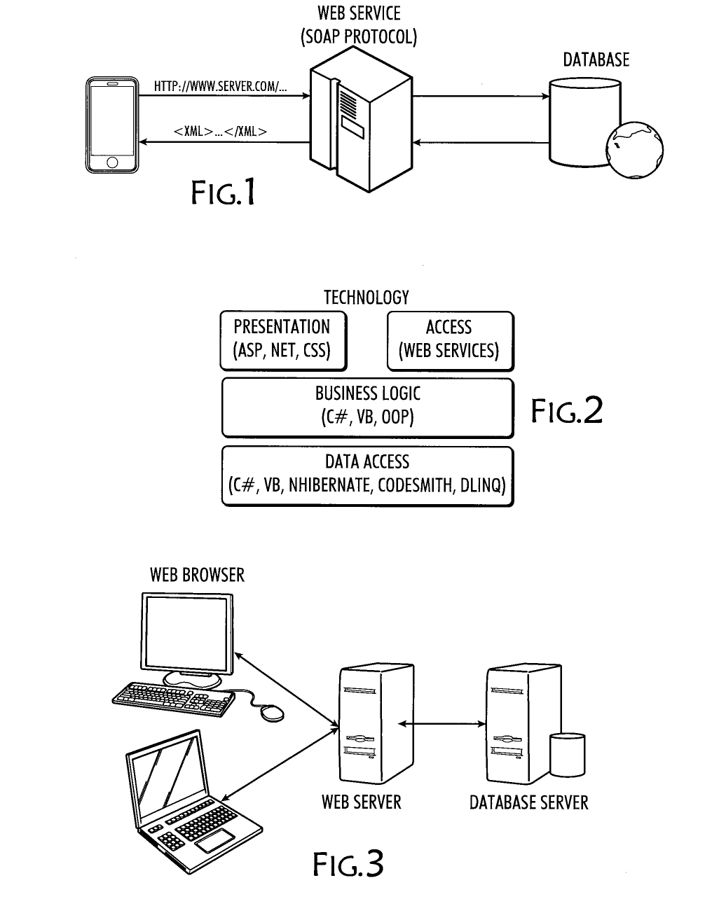

The technology for carrying out the process of the current application is illustrated in FIGS. 1 through 3. The technology for the mobile application provides a database for communicating with the web server which is in communication through a social networking technology with the mobile application as illustrated in FIG. 1.

FIG. 2 illustrates website communication with similar technology including a database server and a web server communication with web browsers.

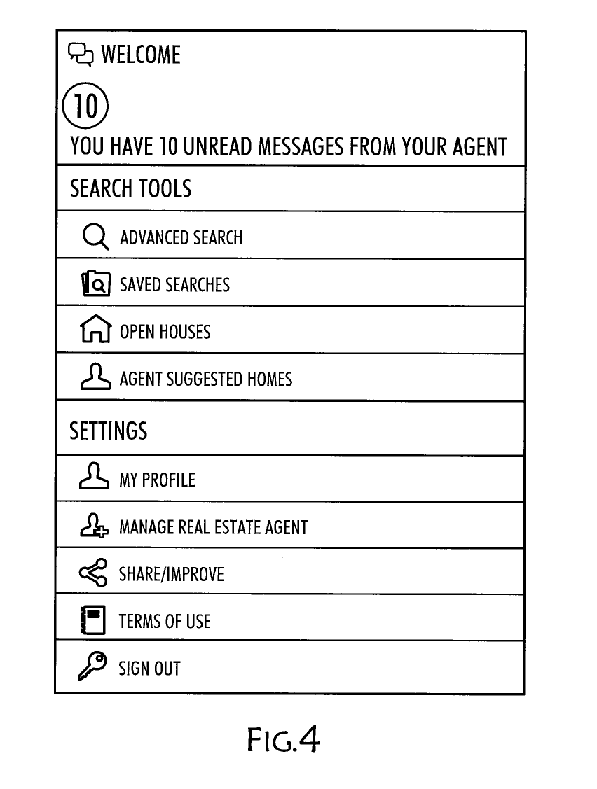

The technology is generally summarized in FIG. 3 illustrating integration of presentation access, business logic, data access and data storage.

### Definition

1. Customers are people who are searching for a home within a geographical area. They can search by street, city, zip code, or schools. The client has the entire suite of tools necessary for managing the searching and buying process of their new home from start to finish.

2. Real estate agents are the sellers and buyers agent for the customers. The agent can manage all their clients, schedule appointments, chat with clients, and more within the application.

3. Real estate managers are the people responsible for overseeing agents. The application allows them to view agents checking in and check out status, receive emergency alerts and more.

### Customer Version

The customer version is designed specifically for the end user (customer). The main focus is to give the customer one place to search, communicate with their agent, compare, rank, organize and give feedback on homes.

The home screen is the main landing page of the mobile application. Customers can access the general features by clicking on the various icons.

The application is unique in that it has a section “My Files.” The customer application is a set of features that are related to a specific home that the customer has selected from the search results. Think of this as a filing cabinet with the following built-in features and icons:
My notes
My photos
My videos
My recordings
My showings
Agent Chat

This feature allows the customer to build its own virtual file on the home(s) they are searching. These features are specific to a single home. Each home has its own file/section.

The customer version can be accessed from a website and or downloaded from iTunes or Google Market Place to the customer's mobile device (phone or tablet).

The simple search features searches the MLS database based on the customers search criteria. The simple search feature is located at the top of the application on all pages throughout the app.

The search can be based on one or more of the following:
City and State
School
Zip Code

The application searches the MLS database based on the customers search criteria. The customer can then save the search criteria for later use. Once the user finds the home, they can add to favorites or start using these features. The following is a list of features found in the left slide out menu, also illustrated in FIG. 4.

Features:
Search Tools:
   Advanced search
   Saved searches
   Open houses
   Agent suggested homes
Settings:
   My Profile
   Manage real estate
   Favorite homes
   Schedule showing
   Share Quitchet/Improve Quitchet
   Terms of Use
   Sign out

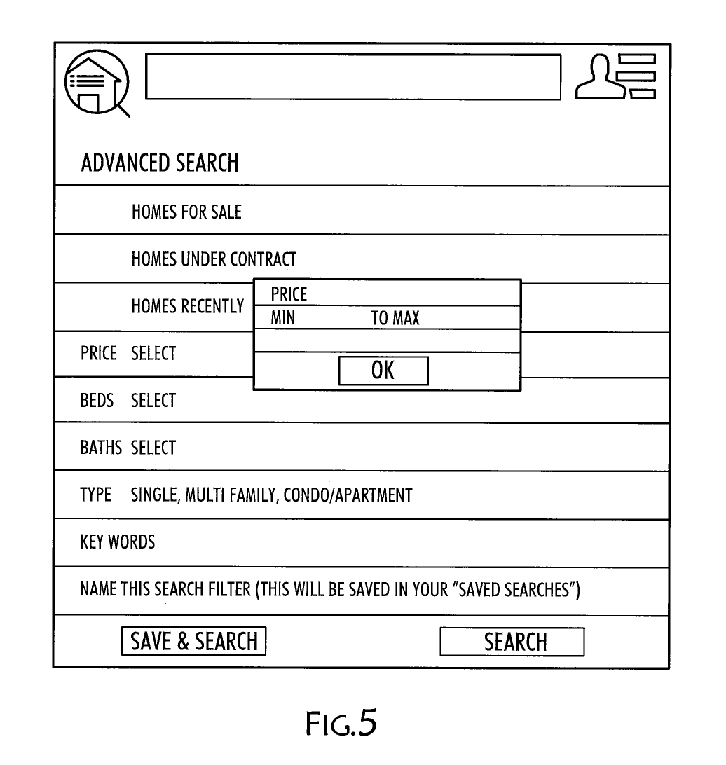

When the user selects “Advanced Search” from the left menu, the screen illustrated in FIG. 5 will appear in the body of the application. The customer can click “Save & Search” (this will save the search criteria to the customers Saved searches. Or they can simply click “Search.”

Features:
Home for sale
Homes under contract
Homes recently sold
By price
Number of beds
Number of baths
Home type
Key words (features)

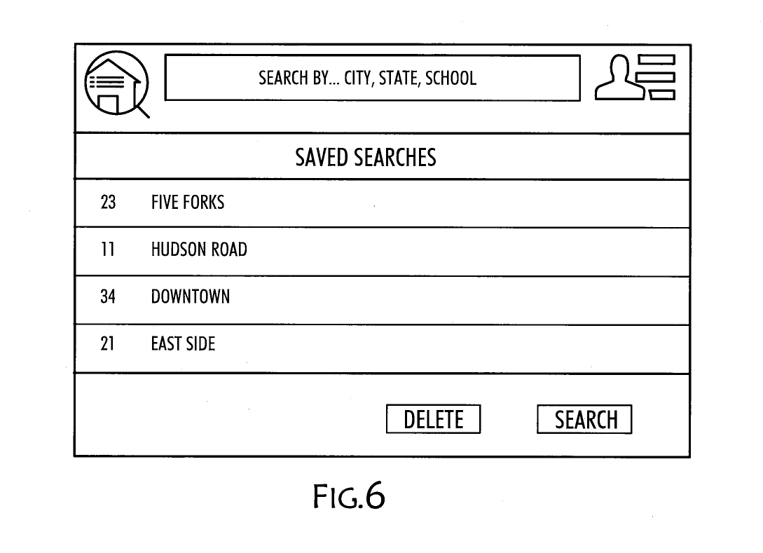

When the user selects “saved searches” from the left menu, the screen of FIG. 6 will appear in the body of the application. The customer can select the previously saved search from the list.

Features:
Displays number of homes in that search criteria
Lists the saved search title
Delete selected saved searches

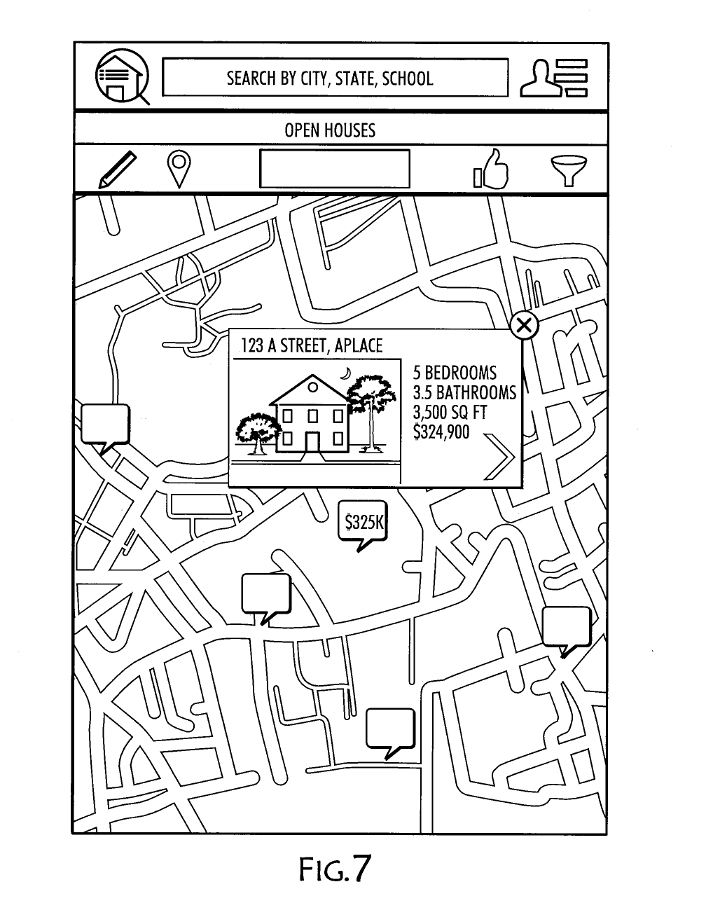

When the user selects “Open Houses” from the left menu, the screen of FIG. 7 will appear in the body of the application. The customer can select one of the Home icons to reveal the details of the home. The customer can search a specific area for Open Houses or they will show the ones in the saved search area(s). The customer can select “open houses” to create a saved “tour” and the app will map them to each home and open files on each home via GPS enabling or manually.

Features:
Address
Main photo
Beds
Baths
Square footage
Price
More Link (right arrow)
Directions

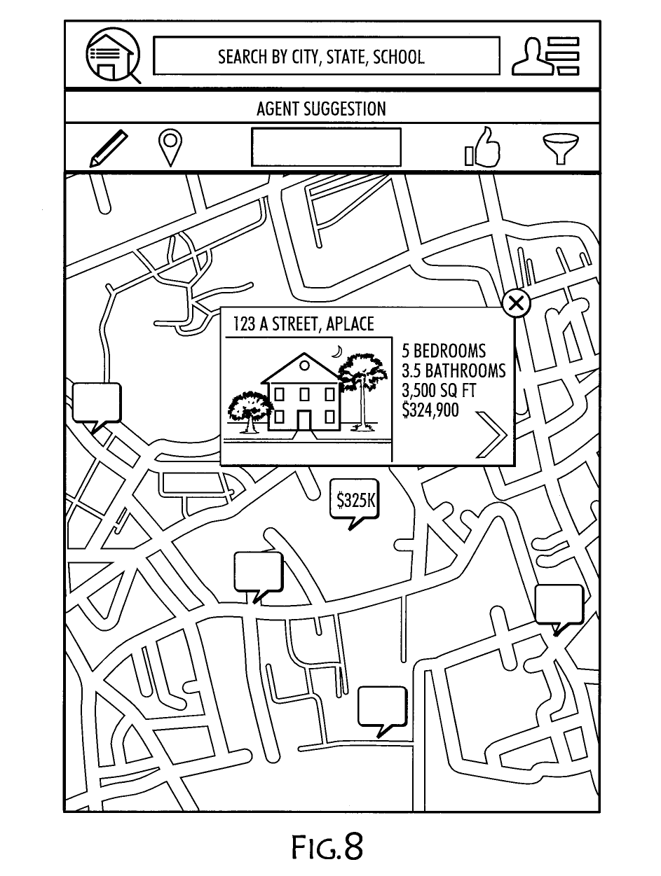

When the user selects “Agent Suggested Homes” from FIG. 8 menu, the screen to the right will appear in the body of the application. The customer can view all the homes their agent has suggested for them to review (map view or list view.)

Features:
Address
Main photo
Beds
Baths
Square footage
Price
More Link (right arrow)
Directions

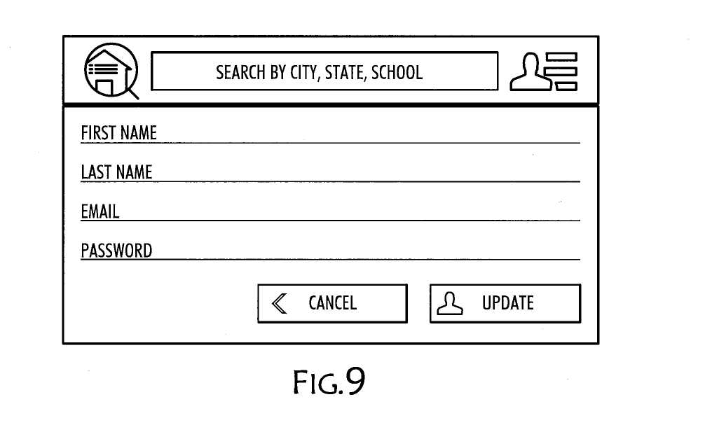

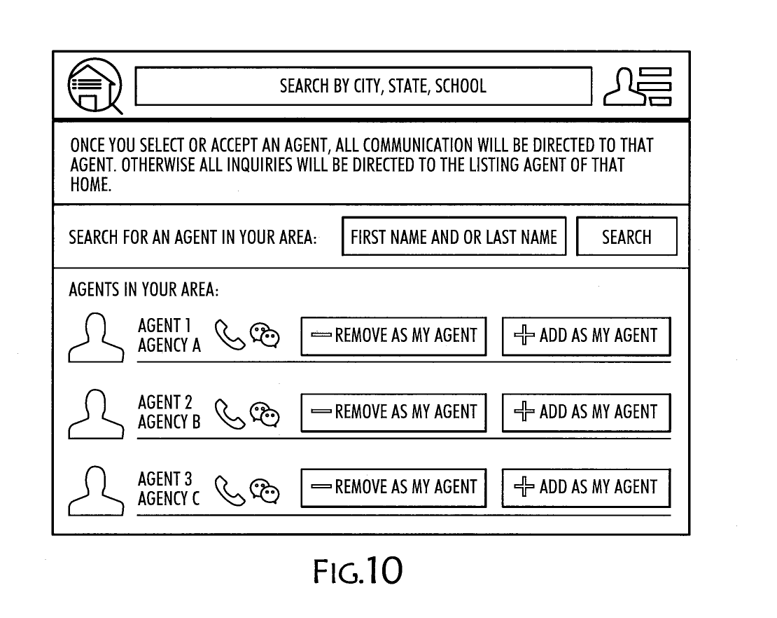

When the user selects “My Profile” from the left menu, the screen of FIG. 9 will appear in the body of the application. The customer can edit their basic information.

Features:
First name
Last name
Email
Password

When the user selects “Manage real estate agent” from the left menu, the screen of FIG. 10 will appear in the body of the application. The customer can search for local agents, they can:

Features:
Call
Text
Remove agent
Add agent

When a customer selects an agent as “My Agent” all other agents names and information will be hidden until or unless the customer removes that agent designated as their agent.

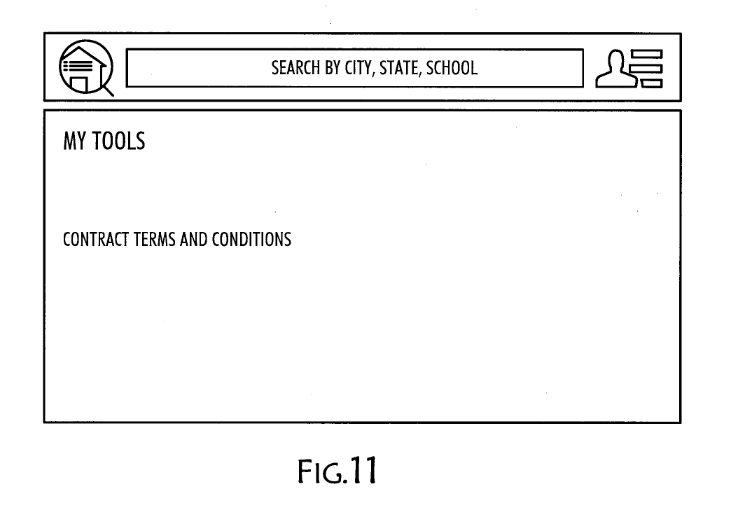

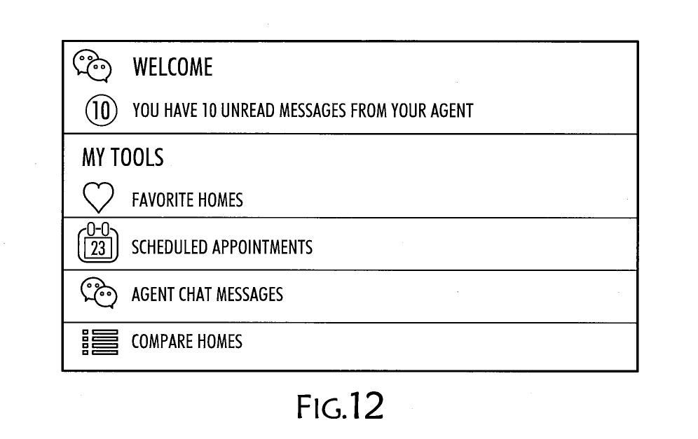

When the user selects “Share” from the left menu, the screen of FIG. 11 will appear in the body of the application. The customer can help us improve the app by leaving us some feedback. They can also share the app with others.

Features:
Improve the app
Facebook
Twitter
Text message
Email

When the user selects “Terms of use” from the left menu, the screen to the right will appear in the body of the application. The customer can read the corporate Terms of Use for the mobile app.

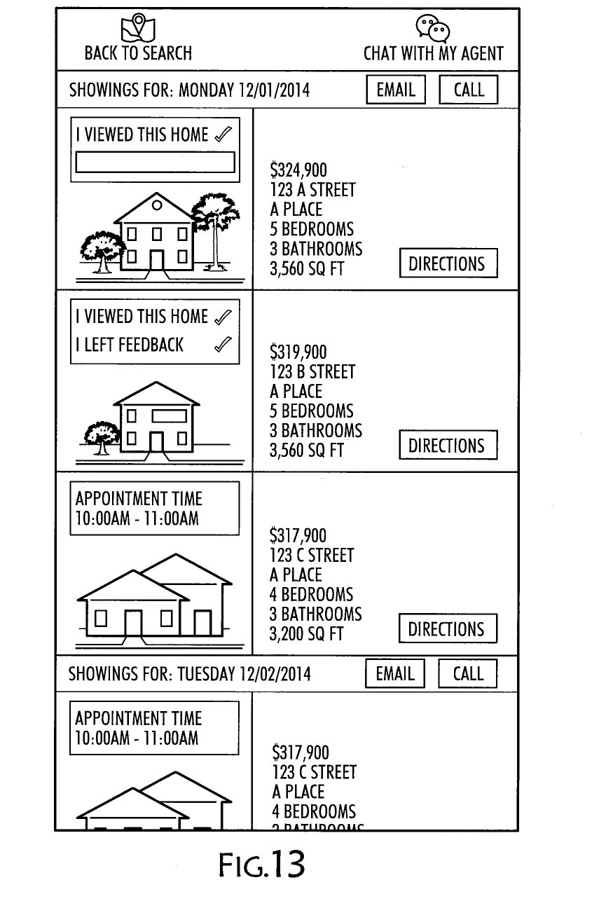

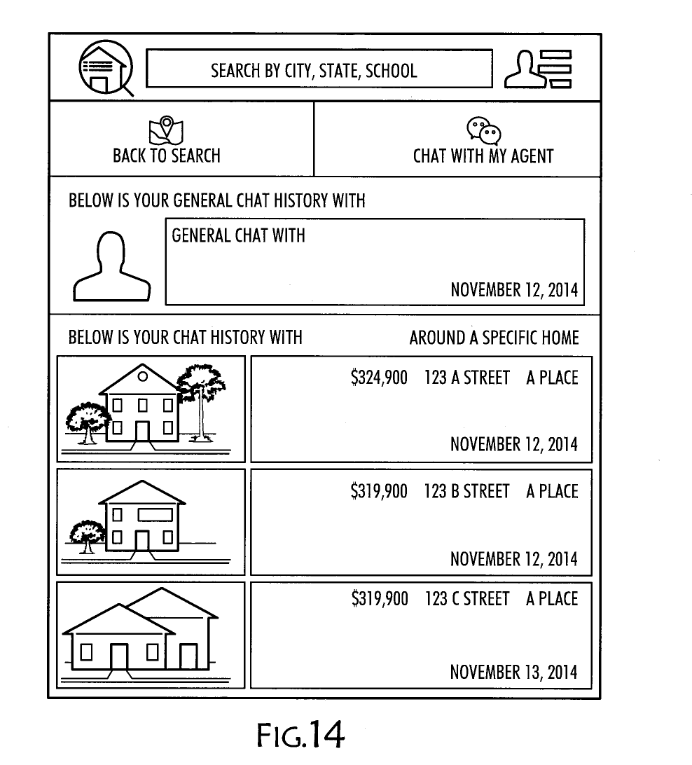

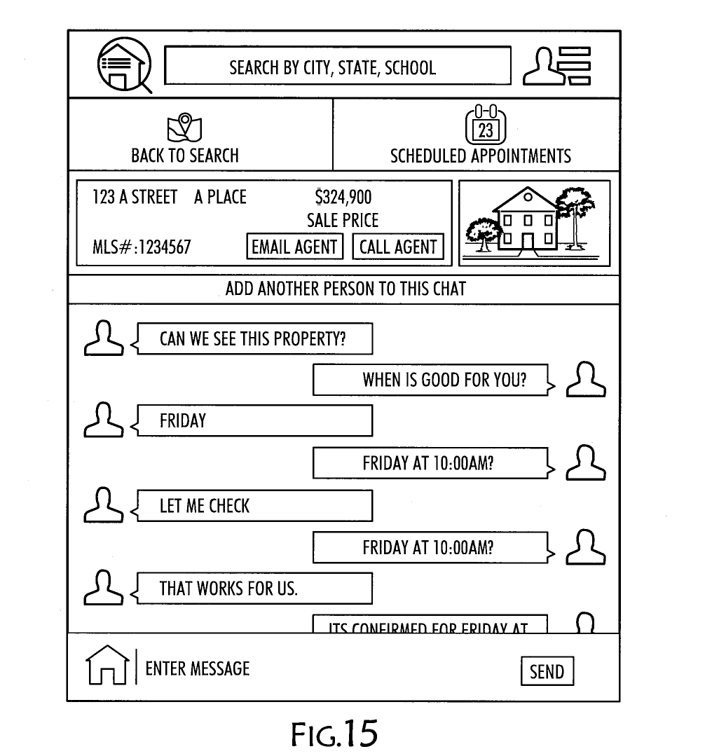

Referring to FIG. 13, the main page of the app is the Map page. This page is has many features for the customer.

Features by reference number:

1. Left icon: By reference number, link to left menu features, search and settings.

2. Quick Search: type in city, state, or school.

3. Right icon: Link to right menu features in My tools.

4. Logo: Link back to main map page.

5. Draw icon: Draw on app the area search boundaries.

6. Map icon: Searches homes based on customer current location/gps location.

7. Search icon: Filter homes by for sale, under contract, recently sold, price, beds and baths.

8. Home pop up window: shows basic information about home selected.

9. Map icons: Color coded map icons showing location of homes.

10. Map button: Takes user back to home page (this page).

11. List button: Shows the homes based on the search criteria in a list view.

The app has a set of tools designed specifically for the customer. The tools are located on the right slide out menu illustrated in FIG. 14. The following is a list of features found in the right slide out menu.

Features:
Favorite homes
Scheduled appointments
Agent chat messages
Compare homes

The app allows the customer to take any home found in their search results and add/remove them to a “Favorite homes” list. The following is a list of features found in the once a home has been added to the Favorite homes section.

Features:
Images (scroll left and right)
MLS details (scroll up and down)
Remove home from Favorites
Share home with agent
Compare home against other favorite homes
Listed by star rating.

The application allows the customer to request a showing (if they have an agent the request goes to their agent, or if not, the request always goes to the listing/sellers agent). The agent will be notified, once the agent sets the date and time for the showing it will notify the customer and display in Scheduled showings. Once accepted this will populate the customer and agent's calendar.

Features as illustrated in FIG. 15:
Back to search
Chat with agent
Directions to the home
Listed showings by date and time
List of past showings
“I viewed the home”
“I left feedback”

The application allows the customer and the associated agent to chat (within the app) around each home. This ensures that all conversation (chats) are grouped and stored within the appropriate home. The Agent chat messages is a list of all the homes that have a chat session. The customer can select the home and review/start or continue a chat dialog. The most recent is always at the top and unanswered chat on each home will be indicated by a bubble icon.

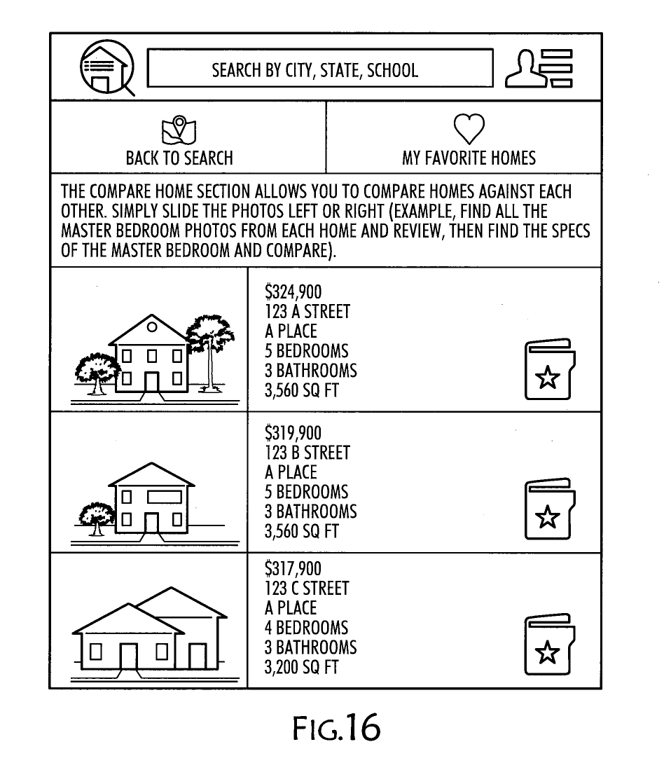

Features (FIG. 16):
Back to search
Chat with agent
List of homes with chat session
Separated by general chat with agent and by homes

Once the customer selects a home that has a chat history (see above Agent chat message) they are taken to the actual chat message history.

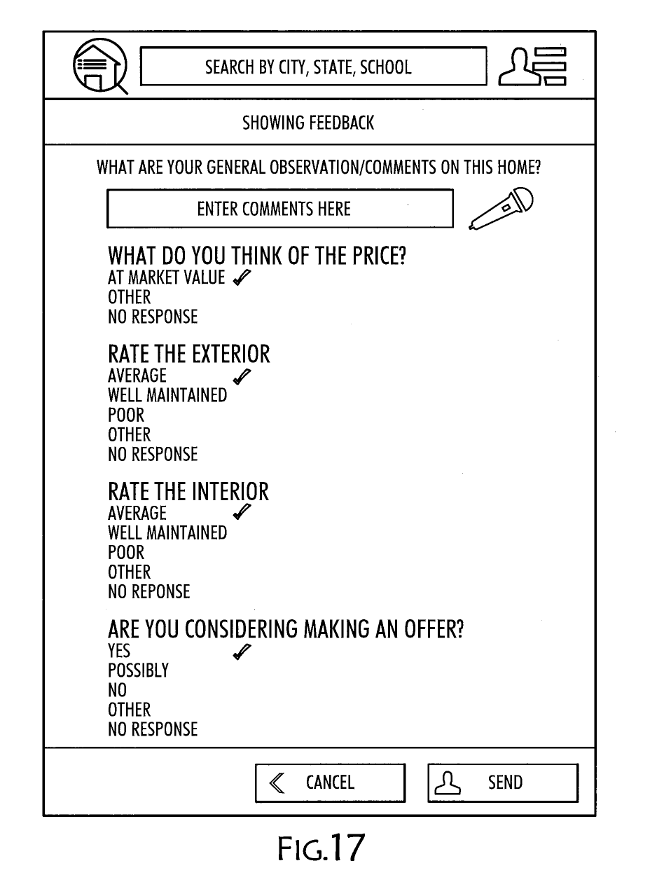

Features (FIG. 17):
Back to search
Schedule a showing
My Files
Add to favorites
Display house details
Email agent
Call agent
Picture of customer and agent
Enter message
Link to Map/Home

The Compare Homes feature allows the customer to select as many homes as they desire from the “Favorite Homes” list. Once the homes are selected and then added to the “Compare Homes” page, the customer can compare all the details side by side with each home.

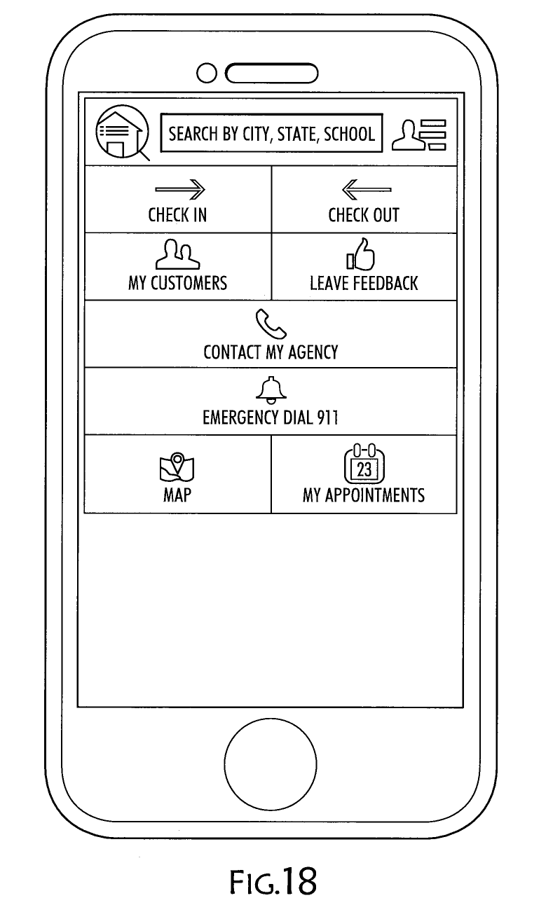

Features (FIG. 18):
Back to search
My favorite homes
Images (slide left and right)
MLS details (slide up and down)
My Files (access all personal images, notes, video, audio, scheduled showing and chat messages).
   The Closer Look—Compare Homes feature allows the customer to access all the apps that makeup My Files.

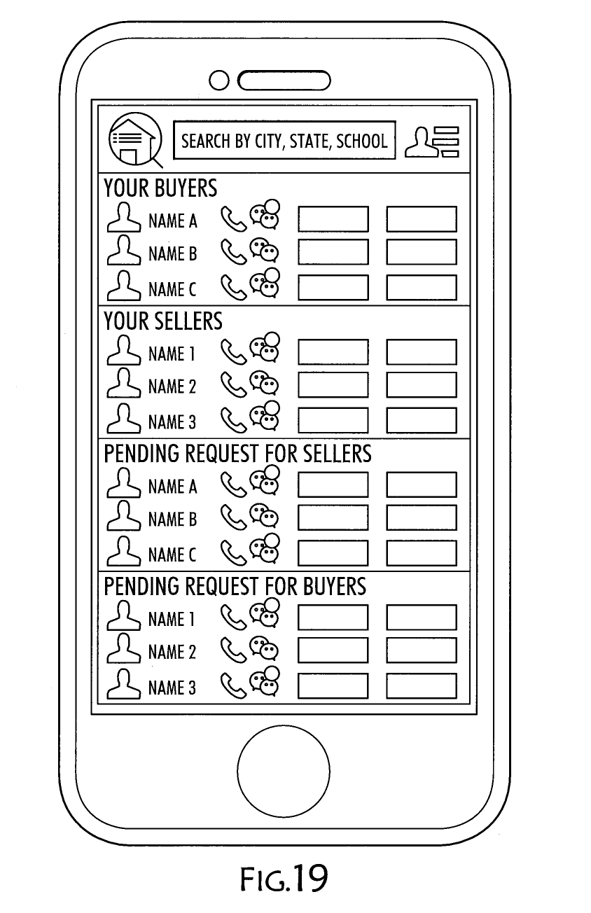

Features (FIG. 19):
Back to search
Home details
Email agent
Call agent
Add/edit notes
Add/edit photos
Add/edit video
Add/edit voice recording
Request showing
Driving directions
Chat with agent
Top 3
Rate this home (3 star)

The Closer Look—Home Details is the main page of all homes in the system. When selected the customer can see all of the MLS details.

Features:
Back to search
Chat with agent
Schedule showing
My Files
Add to Favorites
MLS details
Directions
Email agent
Call agent

The Closer Look—Showing Feedback feature allows the customer to send feedback on the home (after they have visited) back to their showing agent. If they don't have a selected agent it will go directly to the listing agent.

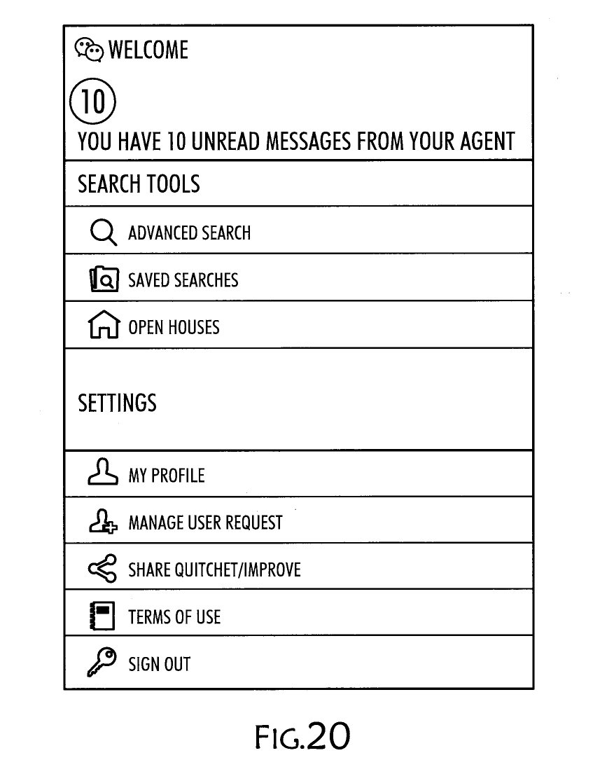

Features (FIG. 20):
Speech or text general comment
Type general comments
Sent to agent via email
Auto updated on Scheduled showing that Feedback was left.

The agent version is designed specifically for the professional agent. The main focus is to give the agent one place to search, communicate with their customers, compare, rank, organize and give feedback on homes. The agent version has all of the features of the customer version but has additional features as described below.

The agent status is the main landing page of the agent version mobile application. The agent has several options once they log in.

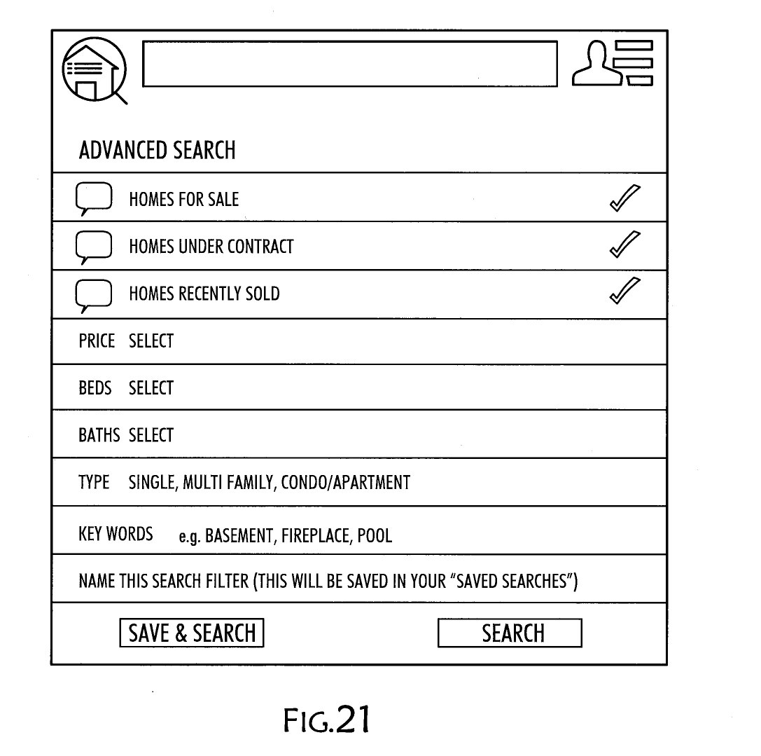

Features (FIG. 21):
Check in to the property
Check out of the property
My customer
Leave feedback
Contact my agency
Dial 911
   The agent version can be accessed from a website and or downloaded from iTunes or Google Market Place to the customer mobile device (phone or table).

Agents have access to the customers they are connected with and users who are requesting to be customers. Agents can click the “Favorite homes” next to their customer and access the customers options. This feature connects the agent and the customer with each and every home added to favorites by the customer.

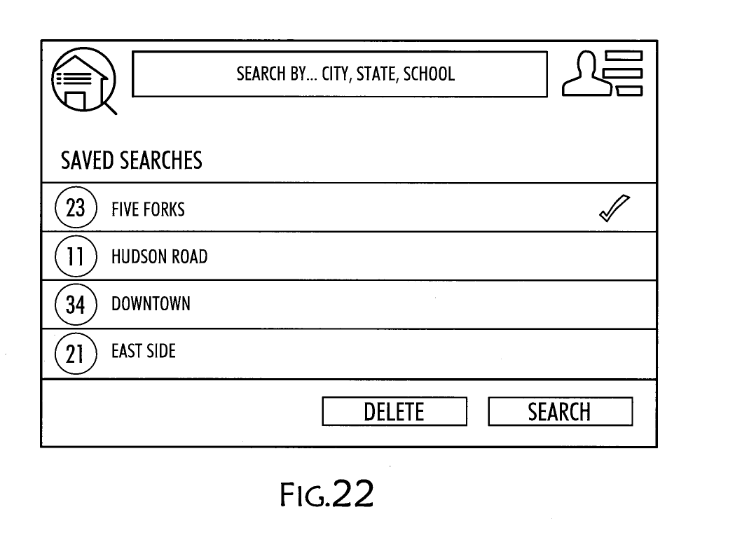

Features (FIG. 22):
Your buyers (remove, connect, share)
Your sellers
Pending buyer user request
Pending seller user request

The agent version can be accessed from a website and/or downloaded from iTunes or Google Market Place to the customer mobile device (phone or tablet).

The simple search feature searches the MLS database on the agents search criteria entered (city and state, zip code, school). The agent can also search for customers or users based on first name or last name. The simple search feature is located at the top of the application on all pages throughout the app.

The customer can search based on:
Customer (first or last name)
City and State
School
Zip Code

The agent app searches the MLS database based on the agents search criteria. The agent can then save the search criteria for later use. Once the agent finds the home, they can add to their customers “My Favorites.”

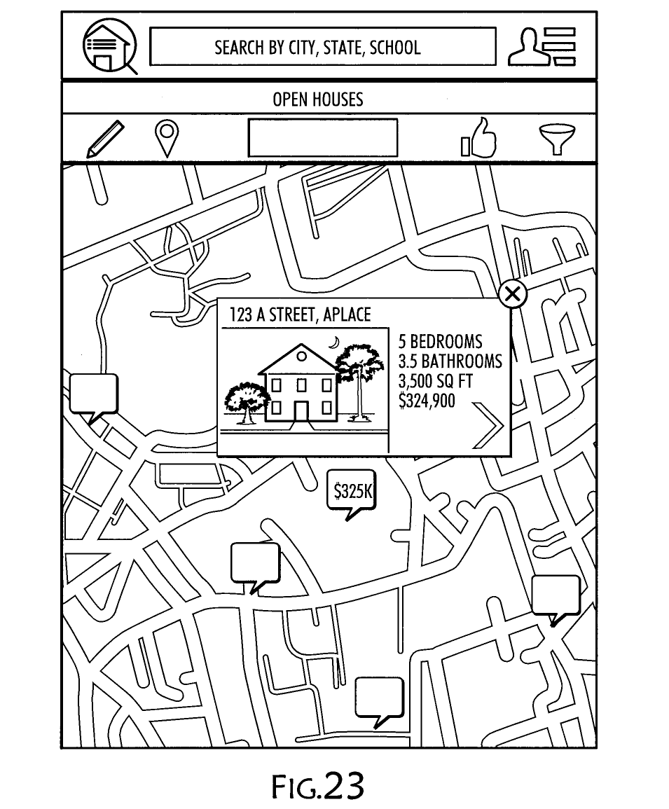

Features (FIG. 23):
Search Tools
   Advanced search
   Saves searches
   Open houses
Settings
   My profile
   Manager user request
   Share Quitchet/Improve Quitchet
   Terms of Use
   Sign Out

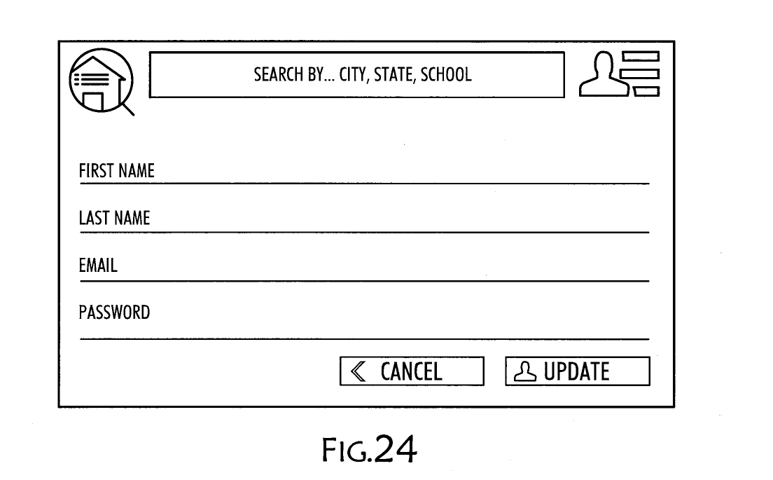

Closer Look—Advanced Search: When the agent selects “Advanced Search” from the menu of FIG. 24, the screen will appear in the body of the application. The agent can set their search criteria and can click “Save & Search” (this will save the search criteria to their Saved searches. Or they can simply click “Search.”

Features (FIG. 24):
Home for sale
Homes under contract
Homes recently sold
By Price
Number of beds
Number of baths
Home type
Key words (features)

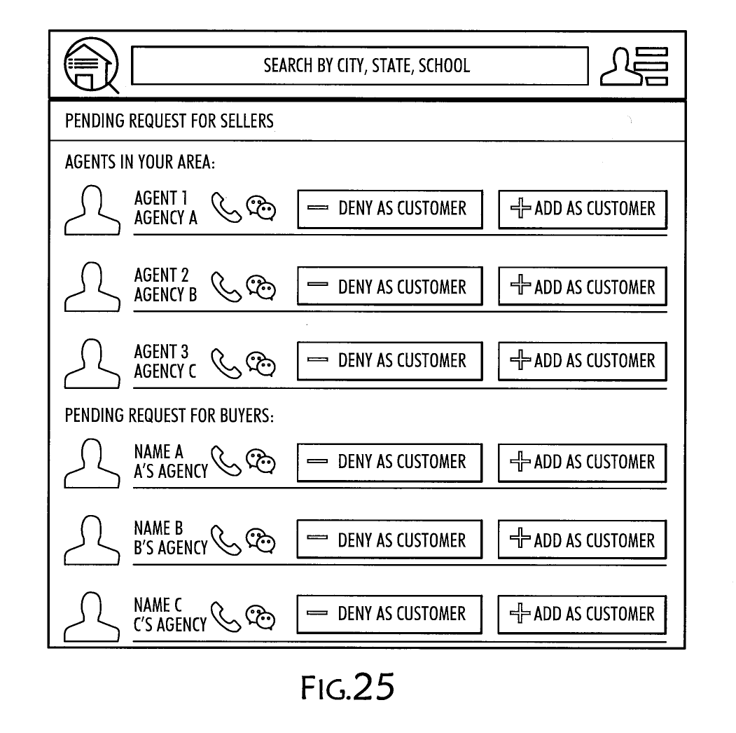

When the agent selects “Saved Searches” from the menu, the screen of FIG. 25 will appear in the body of the application. The agent can select a previously saved search from the list.

Features (FIG. 25):
Displays number of houses in that search criteria
Lists the saved search title
Delete selected saved searches

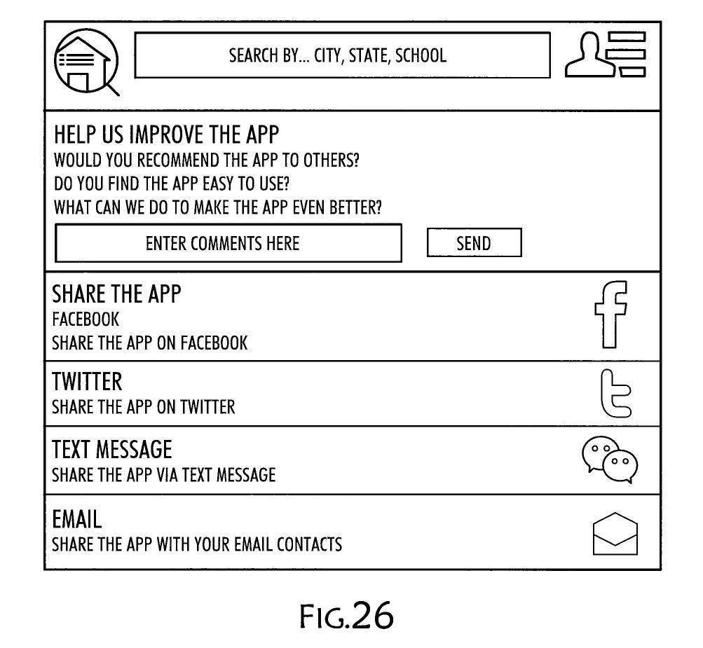

When the agent selects “Open Houses” from the menu, the screen of FIG. 26 will appear in the body of the application. The agent can select one of the Home icons to reveal the details of the home. The agent can search a specific area for Open Houses or they will show the ones in their saved search area(s). The agent can “add an open house” if they wish to schedule one of their listings for a future date and time. This will show to all users in the open house search field.

Features (FIG. 26):
Address
Main photo
Beds
Baths
Square foot
Price
More link (right arrow)
Directions

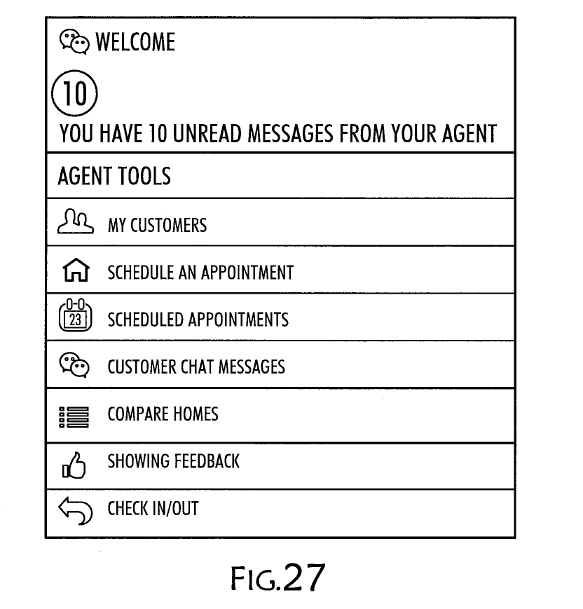

When the agent selects “My Profile” of FIG. 27 from the menu, the screen will appear in the body of the application. The agent can edit their basic information and can also add/edit a full profile visible to all users. A “buyers packet” can be forwarded to any customer through the app when selected as an agent by a user and accepted by the agent as a customer.

Features (FIG. 27):
First name
Last name
Email
Password

They can also add/edit a full profile visible to all users, add a “buyers packet” that can be forwarded to any customer via the app when selected as an agent by a user and accepted by app as a customer function.

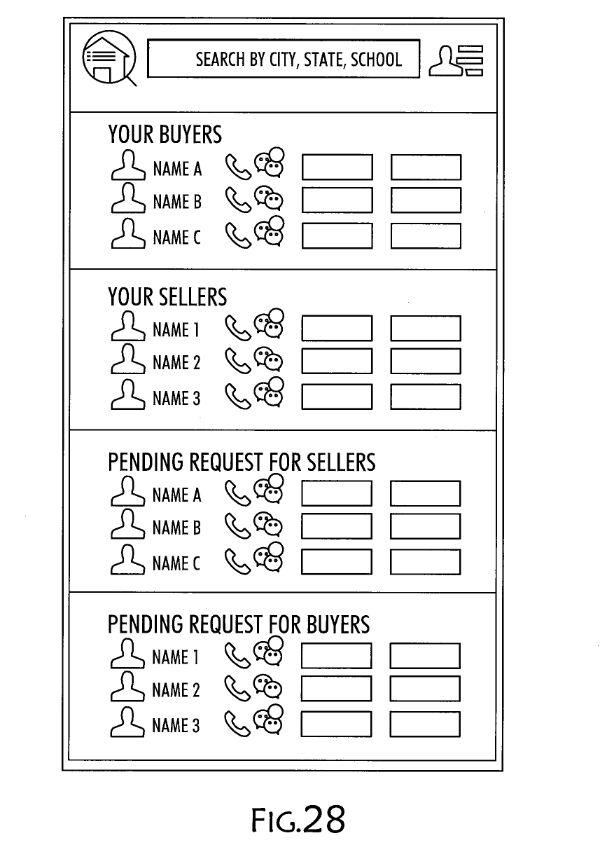

Closer Look—Manager user request: When the agent selects “Manage user request” from the left menu, the screen of FIG. 28 will appear in the body of the application. The agent can manage user request to join as a customer if so desired.

Features (FIG. 27):
Call
Text
Deny as customer
Add as customer

When an agent selects “Add as customer” an email and text will be automatically sent to the user welcoming them as a new customer. This will include the “buyer packet” if created by that agent. The user is then added to the Agent customer (home) screen once they have accepted the invitation. This agent becomes that users “My Agent.”

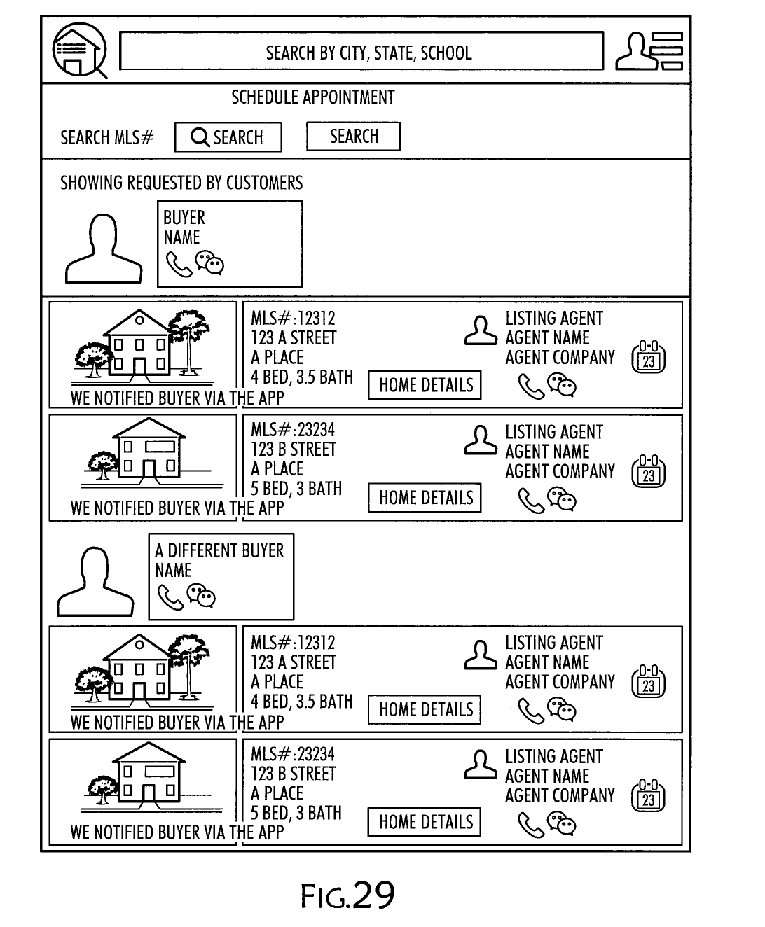

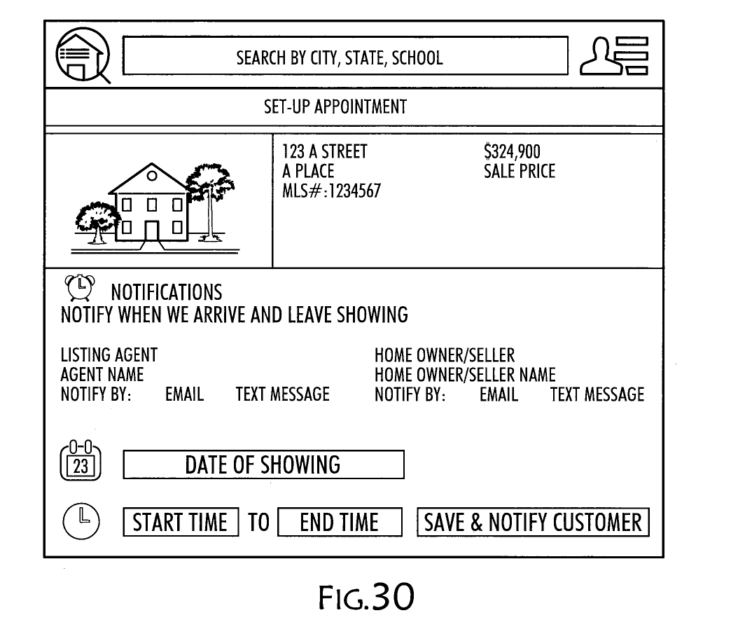

When the agent selects “Share” of FIG. 29 from the left menu, the screen will appear in the body of the application. The agent can help improve the app by leaving feedback. They can also share information with others.

Features (FIG. 29):
Improve this app
Facebook
Twitter
Text Message
Email

When the agent selects “Terms of Use” from the left menu, agent can read the corporate Terms of Use for the mobile app.

When the agent searches for homes in the agent version, the results are displayed in a Map view. The agent has access to several features:

Features list:
12. Left icon: link to left menu features, search & settings.
13. Quick Search: type in city, state, or school.
14. Right icon: link to right menu features in My tools.
15. Logo: link back to main map page
16. Draw icon: draw on app the area search boundaries.
17. Map icon: searches homes based on customer current location/gps location.
18. Search icon: filter homes by for sale, under contract, recently sold, price, beds and baths.
19. Home pop up window: shows basic information about home selected.
20. Map icons: color coded map icons showing location of homes.
21. Map button: takes user back to homepage (this page).
22. List button: shows the homes based on the search criteria in a list view.

When the agent selects a home from the search results, the details of the home (pulled from MLS) will be displayed. The agent can add this home to their customer(s) “Agent suggested homes” section within the customer app.

Features:
MLS details
Directions
Share with Customers
Image slider

### Agent Tools

The agent version has a set of agent tools designed specifically for the agent. The tools are located on the right slide out menu (FIG. 30.)

Features:
My customers
Schedule an appointment
Scheduled appointments
Customer chat messages
Compare homes
Showing feedback
Check In/Out

When the agent clicks on “My Customers” the agent has access to the customer and user who is requesting to be a customer. The agent can manage their customers and access each customer “My Favorite Homes.”

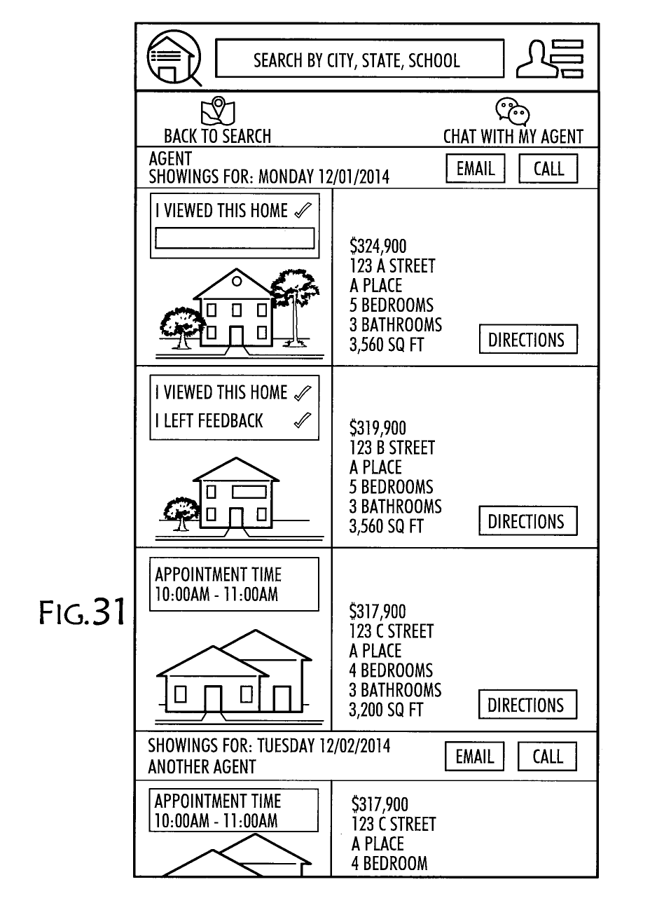

Features (FIG. 31):
Phone
Chat
Remove customers
Add customers
Deny user request
Access Favorite homes (by customer)

### Closer Look—Schedule An Appointment

When a customer requests a showing the agent is notified via mobile pop up. The agent can then view all the showing requests grouped by customer. When order is selected all phone appointments are grouped by contact telephone number with time slots noted by each home. The agent can place multiple appointments in order by sliding up and down the list view and assign them a date. They can also be arranged in map view by touching the home screen. The agent can phone or contact the MLS indicated party (individual or appointment contact company) populated from the MLS information to schedule a showing. The appointment can be expedited through the scheduler of the application. The agent would then select the date and time and the app would notify customer via the app with the details after the appointment has been confirmed.

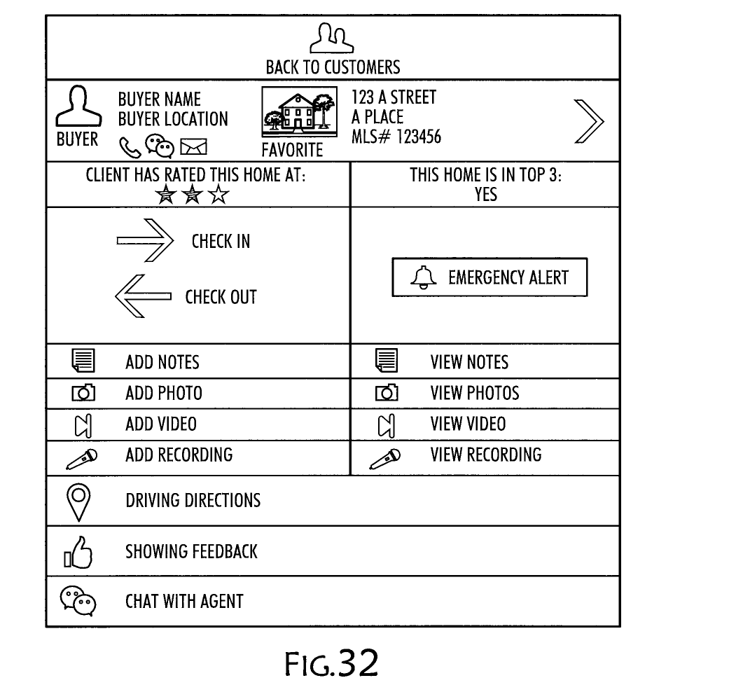

Features (FIG. 32):
Customer information
Home details
Direct text or email chat
Designated contact company or Listing Agent phone, text, email or link to schedule appointment (from MLS data)
Schedule showing
PRO app shows the listing agent contact name and listing number and email in this view and scheduled showing view for ease of contact prior to or during showing session.

When the agent sets the appointment in the app, the application will set the date and time of the appointment in the calendar of agents customer and the agent opt to send the listing agent and seller an email or text alert when arriving and leaving the appointment.

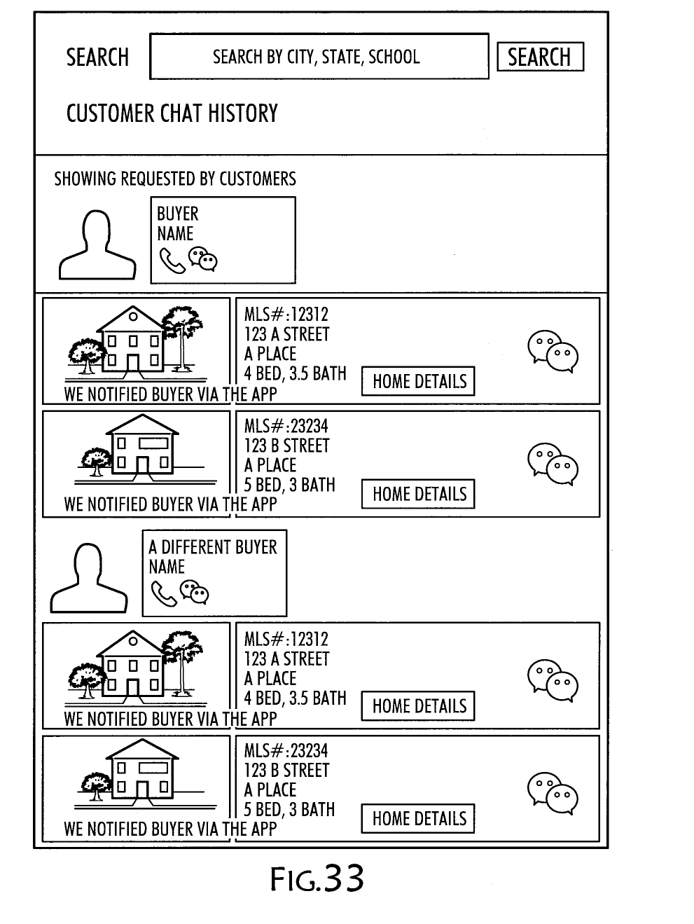

Features (FIG. 33):
Notify seller and listing agent
Set date and time range

The agent can view all scheduled appointments for each customer. Once the agent has scheduled an appointment the agent can view in their mobile calendar on this page.

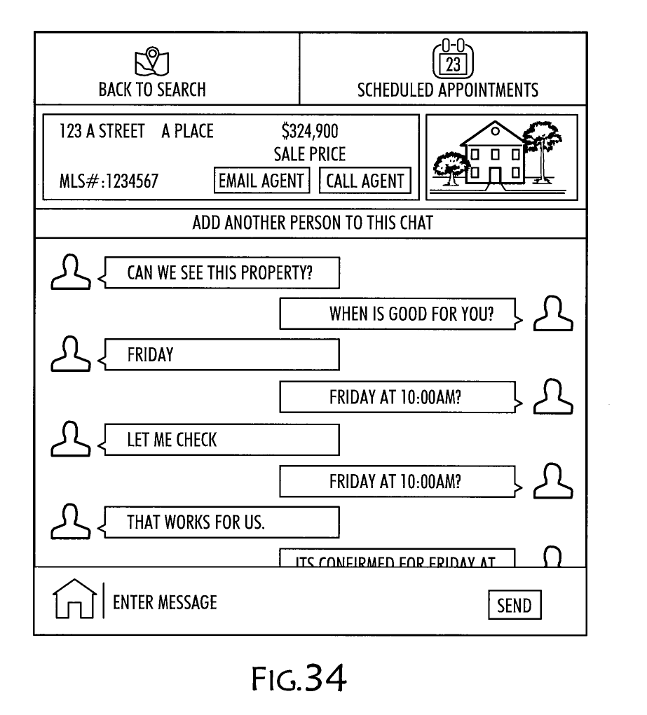

Features (FIG. 34):
Customer name
Showing date and time
Email customer
Call customer
Directions: (always takes you from your present location if GPS is activated)—if not it will show from your designated “home” start point in your GPS.
MLS details (and image slider)
Check in/Check Out alert or manual function=when the agent enters the home, GPS will trigger a 5 grid screen (or it can be manually done) to give options to:
   View home
   Enter feedback
   Check in
   Check out
   Emergency alert

The agent version allows the agent to check in and out of a showing.
Check in/Check out alert functions appear when the agent enters the home GPS will trigger a 6 grid screen to give options to:

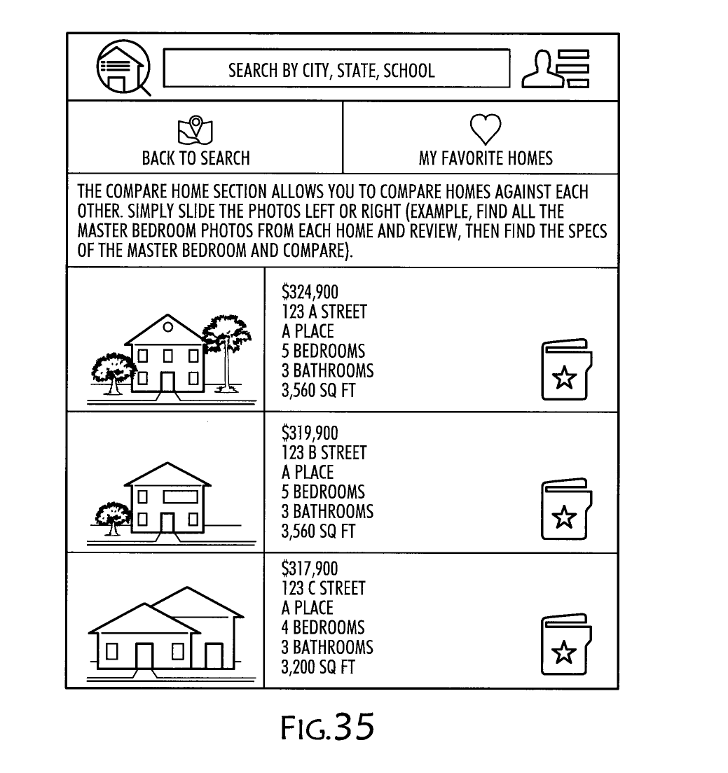

(FIG. 35)
My Customers
Contact my agency
Leave feedback
Check in—this button can activate app needed for lock box access
Check out
Emergency alert

### Closer Look—Customer Chat Messages

The agent app allows the agent and customers to chat around each home. This ensures that all conversations (chats) are grouped and stored within the appropriate home. The Customer chat message is a list of all the homes that have a chat session. The agent can select the home and review/start or continue a chat dialog. The most recent is always at the top and an unanswered chat on each home will be indicated by a bubble icon.

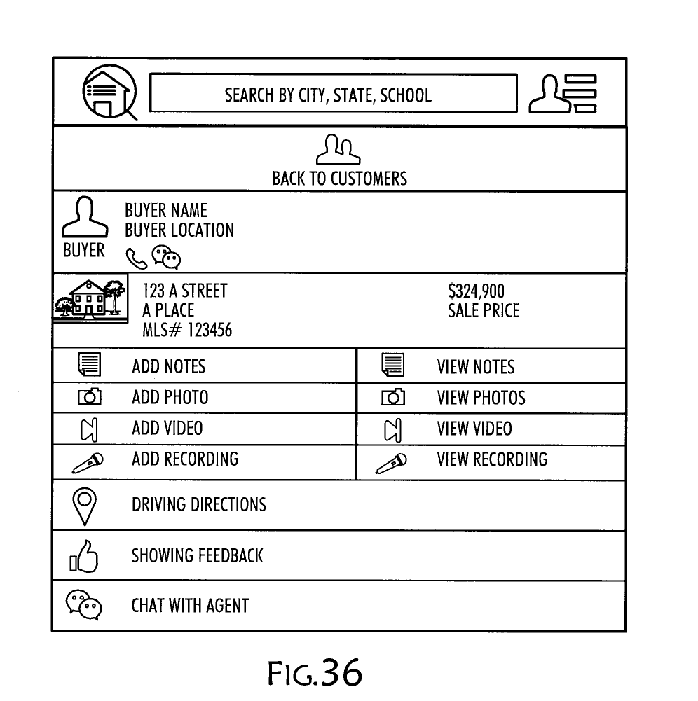

Features (FIG. 36):
Back to search
Chat with customer or agent on each home
List of homes with chat session
Separated by general chat with customer and by homes.

### Closer Look—Customer Chat—History

Once the agent selects the chat icon on a home (see above) the agent is taken to the chat history between the customer and agent around that home.

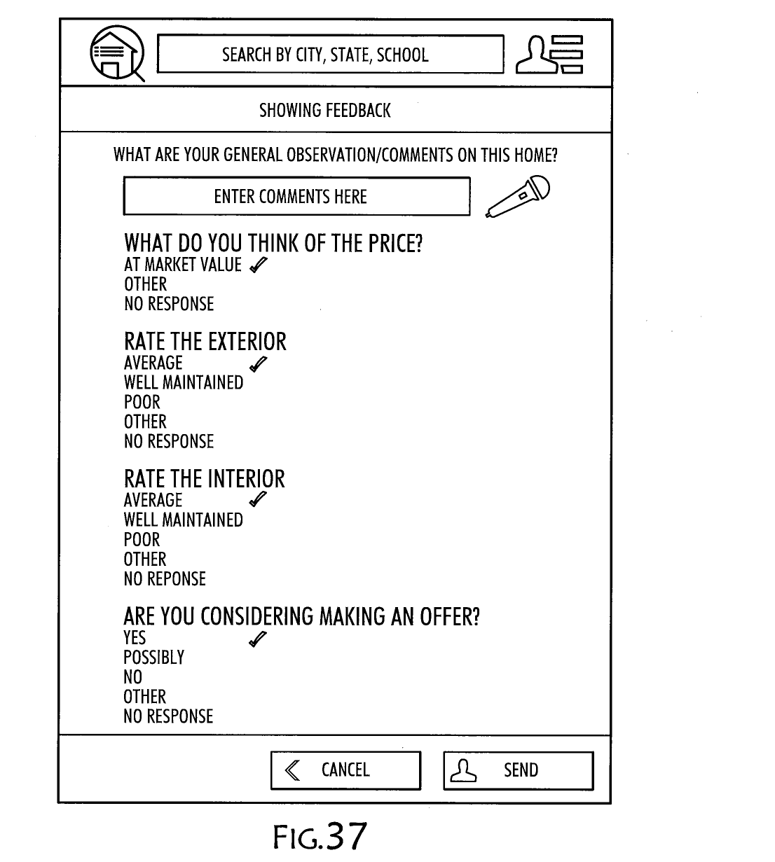

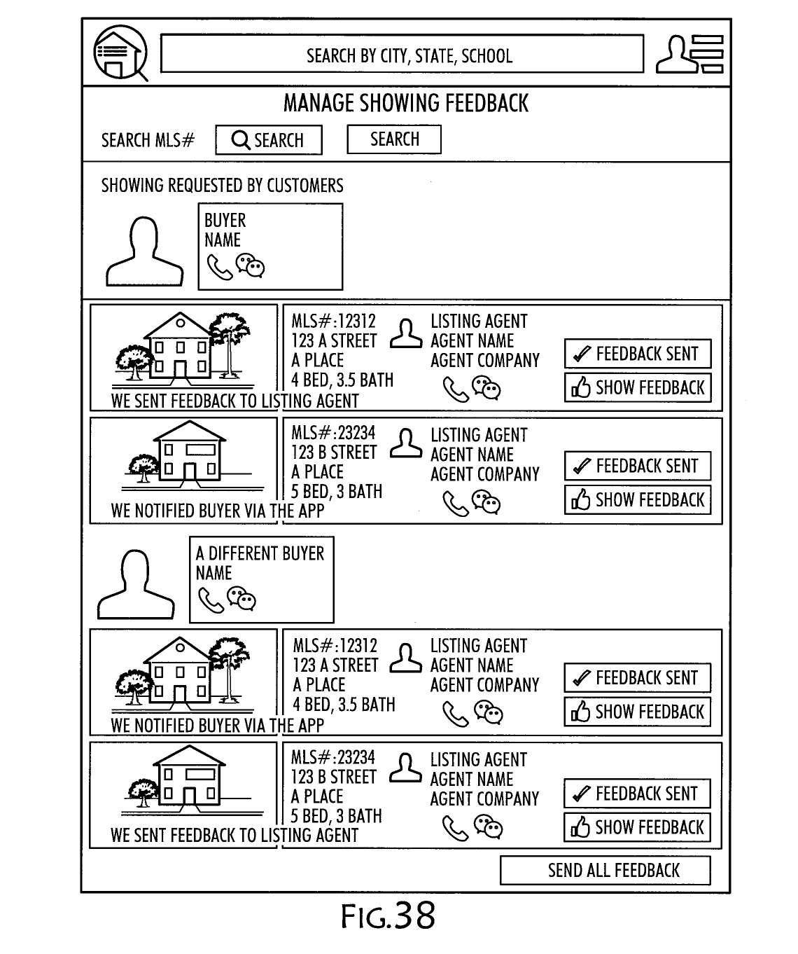

Features (FIG. 37):
Back to search
Schedule a showing
My Favorites
Add to Favorites
Display House Details
Email customer
Call customer
Picture of customer and agent
Enter message
Link to Map/Home

The Compare Homes feature allows the customer to select as many homes as they desire from the “Favorite Homes” list. Once the homes are selected and then added to the “Compare Homes” page the customer can compare all the details side by side for each home.

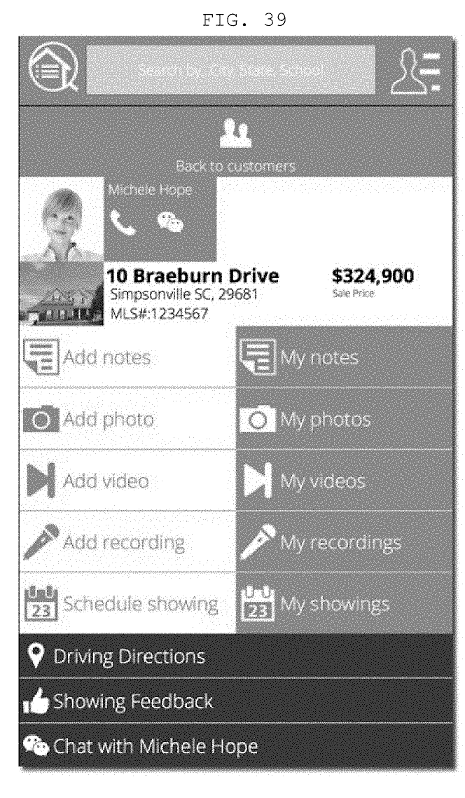

Features (FIG. 38):
Back to search
My Favorite homes
Images (slide left and right)
MLS details (slide up and down)
Home Page (access all personal images, notes, video, audio, scheduled showing and chat messages.)

The Closer Look feature allows the agent to access all the apps that make up the customer version for each customer.

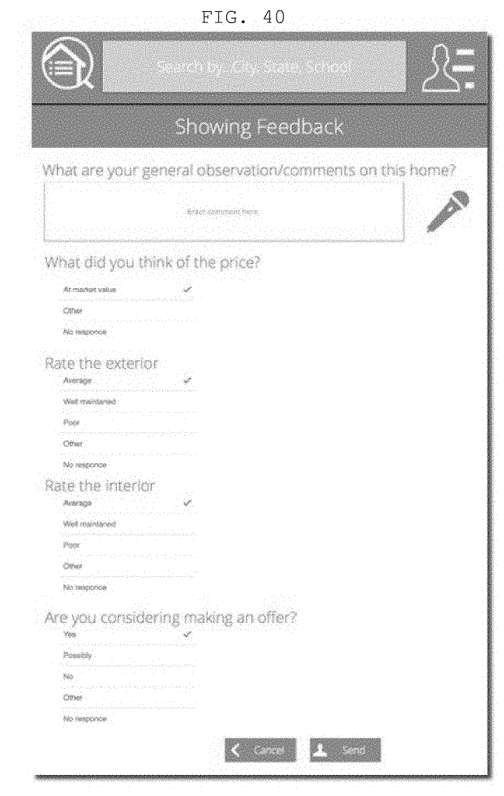

Features (FIG. 39):
Back to search
Home details
Email agent
Call agent
Add/edit notes
Add/edit photos
Add/edit video
Add/edit voice recording
Request showing
Driving directions
Chat with agent

### The Closer Look—Showing Feedback—Form

This feature allows the agent to complete the feedback based on the comments given to them by the buyer and then send feedback on the home (after they have visited) back to their account to be forwarded later to the listing agent.

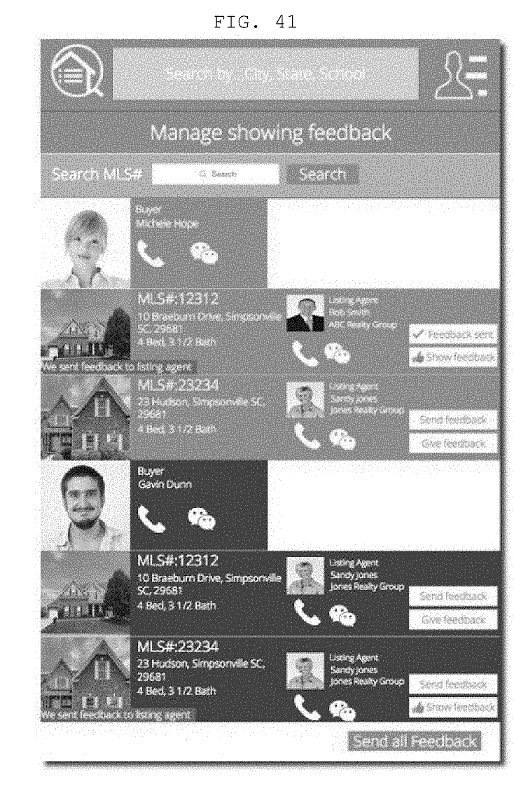

Features (FIG. 40):
Speech to text general comment
Type general comments
Sent to agent via email
Auto updated on Scheduled showing that Feedback was left.

### The Closer Look—Showing Feedback—Manager

This feature allows the agent to view and send the feedback to the listing agent.

Features (FIG. 41):
Phone or chat with customer
Send feedback to listing agent
Add feedback for customer
Phone, text or email listing agent

There are additional features within the agent version to allow for the schedule of showings through the chat features and link to the listing, setting up schedules, showings and verification through the appropriate contact, either a call or showing center, listing company, listing agent or individual, as designated in the listing information. This can be done by text, email, or hyperlink. After confirmation, it is forwarded to the customer for acceptance and loaded into their calendar.

The agent version also has an additional feature that begins to establish procedures for closing. It allows the agent to schedule inspections, link to inspectors, attorneys, and all other parties involved in the closing process. The agent version has safety features; one feature allows the “safety showing screen” to remain on the agent's screen during the open house. They will check in for the start of the open house and check out when all is clear and they are in their car safely. A “911” button is always up for emergency use. The Agent or the Customer viewing the open house can also complete feedback while viewing the home and send it to the listing agent who can then forward to the seller for completion of the open house. The seller then knows that it is safe to return to the property.

### The Manager App

The Manager version is designed specifically for the manager of the agents. The manager can view each agent's scheduled showings. The manager can view the scheduled times, check in and check out status, and how long the agent has been

Agent picture

Phone number/link

Dial 911

Appointment date and time

Address

MLS number

Map link

Customer name and phone number

Check status with time stamp

Check out with time stamp

Timer which stays running until check out

Data gathering to create reports for agents on items such as the number of homes shown until sale, miles traveled, number of customers lost/not converted to sale, etc.

While many feature of this inventive app have been described as set forth above, variations and additions will become apparent to those of skill in the art. Such variations and additions are intended to be included within the spirit and scope of this invention as defined by the following appended claims.

1. A method for managing real estate information on a social network, such social network being accessed through a database server, a web server, communicating with the mobile application providing access for real estate customers, real estate agents, and real estate managers, each having shared but distinct features for each type of user, comprising,
collecting multiple listing service data with a database server permitting the customer to access information from the MLS;
identify open houses from the MLS data, or other methods including, loaded on this app:
inputting data from the open house associated with a particular real estate site;
permitting the agent to enter check-in and check-out information regarding the customer at the open house;
providing safety features to alert emergency personnel if danger arises at he open house,
permitting the agent to notify a seller that the open house has been concluded so that the seller may reenter the premises of the open house.
